(19) United States
(12) Patent Application Publication
(10) Pub. No.: US 2012/0313914 A1
(43) Pub. Date: Dec. 13, 2012

(54) PLASMA DISPLAY DEVICE

(75) Inventors: Koichi Matsumoto, Osaka (JP); Tomoya Nakamura, Osaka (JP); Takahiro Takamori, Osaka (JP); Hidetoshi Hata, Osaka (JP)

(73) Assignee: Panasonic Corporation, Osaka (JP)

(21) Appl. No.: 13/146,937

(22) PCT Filed: Jan. 28, 2011
(86) PCT No.: PCT/JP2011/000466

§ 371 Date: Jul. 29, 2011

(30) Foreign Application Priority Data
Feb. 2, 2010 (JP) 2010-020866

(51) Int. Cl. G09G 5/00; G09G 3/28

(52) U.S. Cl. 345/211; 345/60

(57) ABSTRACT

A plasma display panel has a display region and a non-display region formed around the display region. The rear plate has data electrode that applies a drive voltage to the rear plate, a dummy electrode that is in parallel with the data electrode and does not apply a drive voltage to the rear plate, an insulating layer that coats the data electrode and the dummy electrode, and a plurality of horizontal barrier ribs formed on the insulating layer and orthogonal to the data electrodes. The data electrode is arranged in the display region and the non-display region. The dummy electrode is arranged in the non-display region. An outermost horizontal barrier rib is arranged in the non-display region. The outermost horizontal barrier rib is opposed to the data electrode via the insulating layer, and is not opposed to the dummy electrode.

### TECHNICAL FIELD

A technique disclosed here relates to a plasma display device for use in a display device and the like.

### BACKGROUND ART

A plasma display device using a plasma display panel (hereinafter referred to as PDP) as a display device holds the PDP on the front side of a chassis member made of metal such as aluminum. Further, the plasma display device has a drive circuit board constituting a drive circuit that generates a drive voltage for allowing the PDP to emit light (e.g. see Patent Document 1).

The PDP is configured of a front plate and a rear plate. The front plate is made up of a glass substrate, display electrodes formed on one main face of the glass substrate, a dielectric layer that coats the display electrodes and functions as a capacitor, and a protective layer made of magnesium oxide (MgO) and formed on the dielectric layer. Meanwhile, the rear plate is made up of a glass substrate, data electrodes formed on one main face of the glass substrate, an insulating layer that coats the data electrode, barrier ribs formed on the insulating layer, and phosphor layers that are formed between each barrier rib and respectively emit red, green and blue light.

### PRIOR ART DOCUMENT

### Patent Document

[Patent Document 1]: Unexamined Japanese Patent Publication No. 2003-131580

### SUMMARY OF THE INVENTION

A plasma display device includes a PDP having a front plate and a rear plate opposed to the front plate. The PDP has a display region and a non-display region formed around the display region. The rear plate has an electrode that applies a drive voltage to the rear plate, a dummy electrode that is in parallel with the electrodes and does not apply a drive voltage to the rear plate, an insulating layer that coats the electrodes and the dummy electrode, and a plurality of barrier ribs formed on the insulating layer and orthogonal to the electrodes. The electrode is disposed in the display region and the non-display region. The dummy electrode is disposed in the non-display region. The insulating layer is disposed in the display region and the non-display region. An outermost barrier rib is disposed in the non-display region. The outermost barrier rib is opposed to the electrode via the insulating layer, and is not opposed to the dummy electrode.

### BRIEF DESCRIPTION OF THE DRAWINGS

FIG. 1 is a perspective view showing a configuration of a PDP according to an embodiment;

FIG. 2 is an electrode array diagram of the PDP;

FIG. 3 is a block circuit diagram of the plasma display device according to the embodiment;

FIG. 4 is a drive voltage waveform chart of the plasma display device;

FIG. 5 is a sectional view showing a discharge cell configuration of the PDP according to the embodiment;

FIG. 6 is a plan view showing a discharge cell structure of the PDP; and

FIG. 7 is a plan view showing a substantial part of a boundary portion between the display region and the non-display region of the PDP.

### DETAILED DESCRIPTION OF THE INVENTION

### 1. Configuration of PDP 100

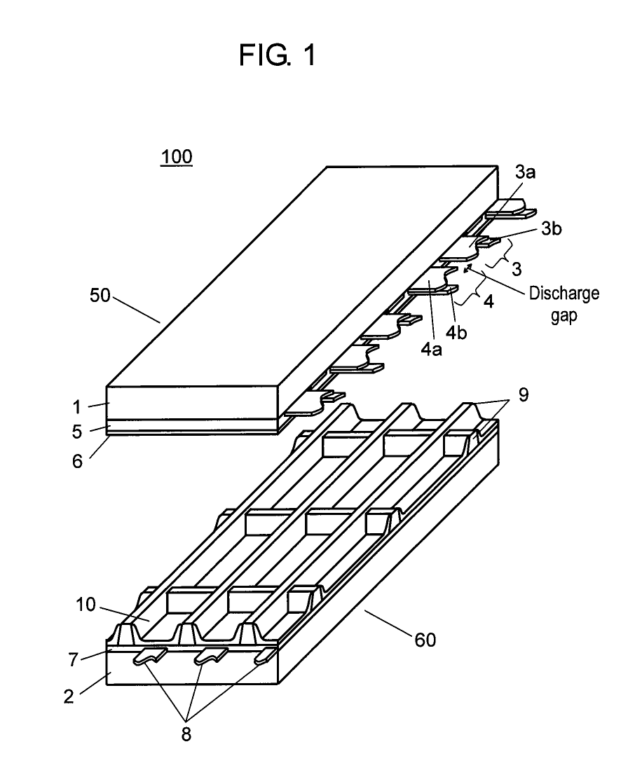

PDP 100 according to the present embodiment is an AC surface discharge type PDP. As shown in FIG. 1, as an example, PDP 100 is configured by arranging front substrate 1 and rear substrate 2, which are made of glass, as opposed to each other so as to form a discharge space therebetween. On front substrate 1, a plurality of scan electrodes 3 and sustain electrodes 4, constituting a display electrode, is formed as paired in parallel with each other, with a discharge gap provided therebetween. Then, dielectric layer 5 is formed which is made of a glass material or the like and coats scan electrodes 3 and sustain electrodes 4. On dielectric layer 5, protective layer 6 made of magnesium oxide (MgO) is formed. Scan electrode 3 is configured of transparent electrode 3a made of indium tin oxide (ITO) or the like, and bus electrode 3b made of silver (Ag) or the like and superimposed on transparent electrode 3a. Sustain electrode 4 is configured of transparent electrode 4a made of ITO or the like, and bus electrode 4b made of Ag or the like and superimposed on transparent electrode 4a. Front plate 50 is one obtained by forming the foregoing constituents on front substrate 1.

On rear substrate 2, a plurality of data electrodes 8 that apply a drive voltage and insulating layer 7 that coats data electrodes 8 are provided. On insulating layer 7, parallel-cross barrier ribs 9 are provided. Barrier ribs 9 partition the discharge space between front substrate 1 and rear substrate 2 as discharge cells. On the front face of insulating layer 7 and the side faces of barrier ribs 9, phosphor layers 10 are provided which emit light of red (R), green (G) and blue (B) colors. Rear plate 60 is one obtained by forming the foregoing constituents on rear substrate 2.

Further, front plate 50 and rear plate 60 are arranged as opposed to each other such that scan electrodes 3 and sustain electrodes 4 intersect with data electrodes 8. Into the discharge space formed between front plate 50 and rear plate 60, for example, a mixed gas of neon (Ne) and xenon (Xe) is filled as a discharge gas with a pressure of 53 kPa (400 Torr) to 80 kPa (600 Torr).

It is to be noted that in the present embodiment, the discharge gas to be filled into the discharge space contains not less than 10 vol % and not more than 30 vol % of Xe.

### 2. Configuration of Plasma Display Device 200

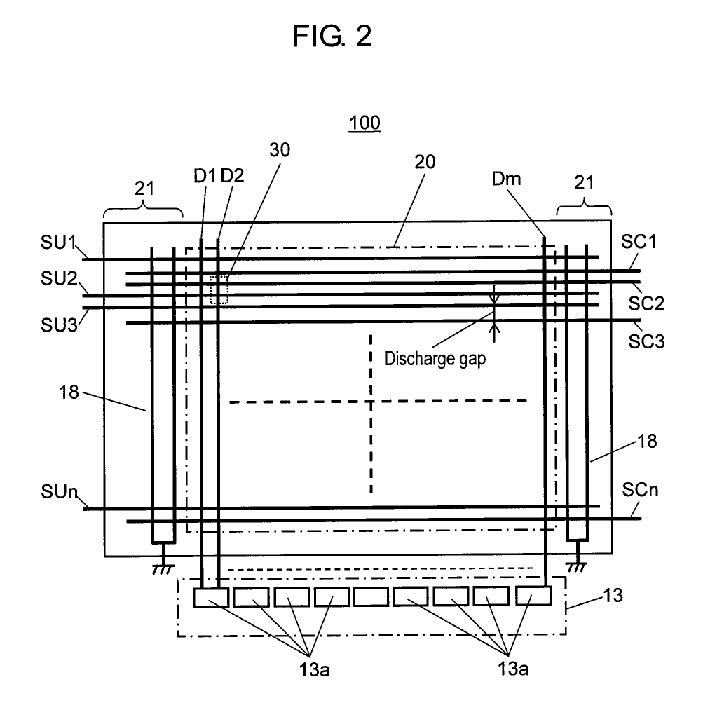

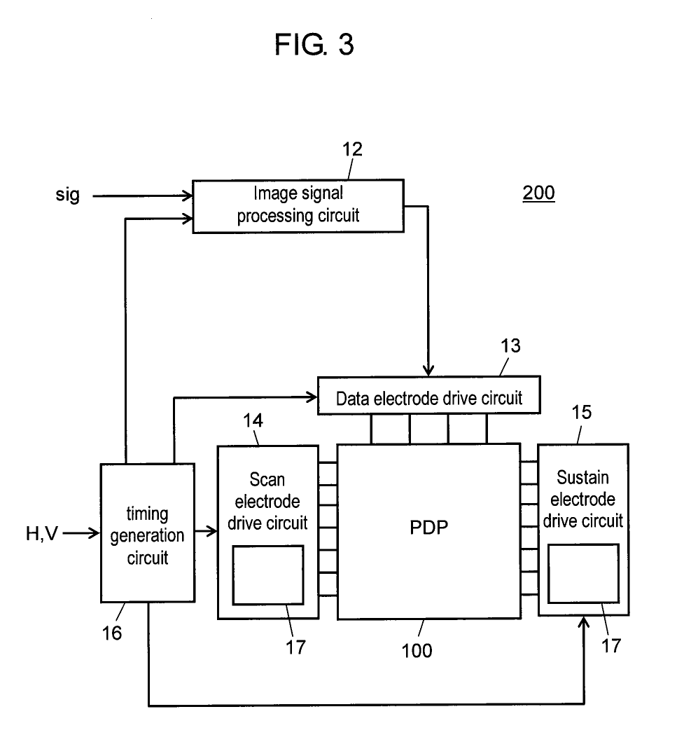

As shown in FIGS. 2 and 3, plasma display device 200 has PDP 100. As shown in FIG. 2, PDP 100 has scan electrodes SC1, SC2, SC3 . . . SCn (numeral 3 in FIG. 1), the number of which is n and which is arrayed as extended in a row direction. PDP 100 has sustain electrodes SU1, SU2, SU3 . . . SUn (numeral 4 in FIG. 1), the number of which is n and which is arrayed as extended in the row direction. PDP 100 has data electrodes D1 . . . Dm (numeral 8 in FIG. 1), the number of which is m and which is arrayed as extended in a column direction. Then, discharge cell 30 is formed in a portion where a pair of scan electrode SC1 and sustain electrode SU1 intersects with one data electrode D1. m×n of discharge cells 30 are formed inside the discharge space. The scan electrodes and the sustain electrodes are connected to a connection terminal provided at a peripheral end of the front plate outside an image display region.

Further, non-display region 21 is provided around display region 20 of PDP 100. In non-display region 21, a plurality of dummy electrodes 18 is formed. In FIG. 2, two dummy electrodes 18 are formed on one side as an example. Dummy electrode 18 is electrically grounded for preventing erroneous discharge.

Further, as shown in FIGS. 2 and 3, plasma display device 200 has data electrode drive circuit 13. Data electrode drive circuit 13 has a plurality of data drivers 13a connected to one ends of data electrodes 8 and made up of semiconductor elements for supplying a voltage to data electrodes 8. Data electrodes 8 are divided into a plurality of blocks with a several data electrodes 8 taken as one block. Further, data electrodes 8 are connected to data driver 13a in units of blocks. That is, plasma display device 200 is provided with a plurality of data drivers 13a.

As shown in FIG. 3, plasma display device 200 includes PDP 100, image signal processing circuit 12, data electrode drive circuit 13, scan electrode drive circuit 14, sustain electrode drive circuit 15, timing generation circuit 16, and a power supply circuit (not shown). Herein, scan electrode drive circuit 14 and sustain electrode drive circuit 15 are each provided with sustain pulse generator 17.

Image signal processing circuit 12 converts image signal sig to image data with respect to each subfield. Data electrode drive circuit 13 converts image data with respect to each subfield to signals corresponding to respective data electrodes D1 to Dm, to drive respective data electrodes D1 to Dm. Timing generation circuit 16 generates a variety of timing signals based on horizontal synchronizing signal H and vertical synchronizing signal V, and supplies the signals to respective drive circuit blocks. Scan electrode drive circuit 14 supplies a drive voltage waveform to scan electrodes SC1 to SCn based on the timing signals. Sustain electrode drive circuit 15 supplies drive voltage waveforms to sustain electrodes SU1 to SUn based on the timing signals.

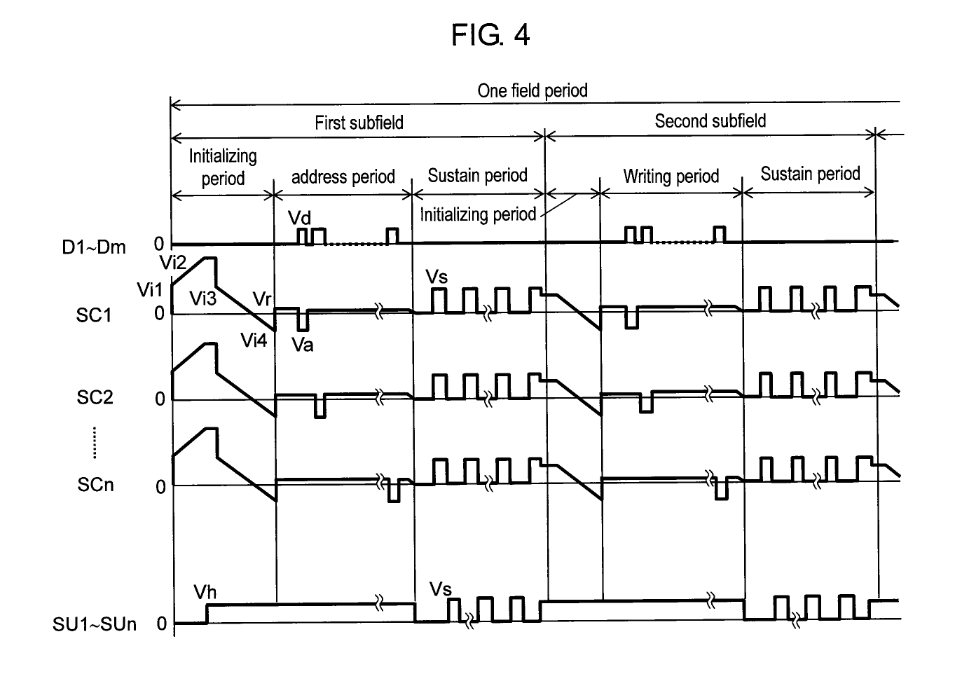

Next, drive voltage waveforms for driving PDP 100 and operations thereof will be described with reference to FIG. 4.

### 2-1. Driving Method for Plasma Display Device 200

As shown in FIG. 4, in plasma display device 200 in the present embodiment, a plurality of subfields constitutes one field. The subfield has an initializing period, an address period and a sustain period. The initializing period is a period when initializing discharge is generated in discharge cells. The address period is a period when address discharge is generated for selecting a discharge cell to be allowed to emit light after the initializing period. The sustain period is a period when sustain discharge is generated in the discharge cell selected in the address period.

### 2-1-1. Initializing Period

In the initializing period of a first subfield, data electrodes D1 to Dm and sustain electrodes SU1 to SUn are held at 0 (V). Further, a ramp voltage, which gradually rises from voltage Vi1 (V) being not higher than a discharge starting voltage toward voltage Vi2 (V) exceeding the discharge starting voltage, is applied to scan electrodes SC1 to SCn. Then, first weak initializing discharge is generated in all the discharge cells. By the initializing discharge, negative wall voltages are accumulated on scan electrodes SC1 to SCn. Positive wall voltages are accumulated on sustain electrodes SU1 to SUn and data electrodes D1 to Dm. The wall voltage is a voltage that is generated by wall charges accumulated on the protective layer 6, phosphor layer 10 or the like.

Subsequently, sustain electrodes SU1 to SUn are held at positive voltage Vh (V). A ramp voltage, which gradually falls from voltage Vi3 (V) toward voltage Vi4 (V), is applied to scan electrodes SC1 to SCn. Thereupon, second weak initializing discharge is generated in all the discharge cells. The wall voltages between scan electrodes SC1 to SCn and sustain electrodes SU1 to SUn are weakened. The wall voltages on data electrodes D1 to Dm are adjusted to values appropriate for the address operation.

### 2-1-2. Address Period

In the subsequent address period, scan electrodes SC1 to SCn are temporarily held at Vr(V). Next, negative scan pulse Va(V) is applied to scan electrode SC1 on the first row. Further, positive address pulse voltage Vd(V) is applied to data electrode Dk (k=1 to m) in a discharge cell to be displayed on the first row out of data electrodes D1 to Dm. At this time, a voltage at an intersecting part between data electrode Dk and scan electrode SC1 is one obtained by adding the wall voltage on data electrode Dk and the wall voltage on scan electrode SC1 to an external applied voltage (Vd−Va) (V). That is, the voltage at the intersecting part between data electrode Dk and scan electrode SC1 exceeds the discharge starting voltage. Then, address discharge is generated between data electrode Dk and scan electrode SC1, and between sustain electrode SU1 and scan electrode SC1. The positive wall voltage is accumulated on scan electrode SC1 in the discharge cell where the address discharge has been generated. The negative wall voltage is accumulated on sustain electrode SU1 in the discharge cell where the address discharge has been generated. The negative wall voltage is accumulated on data electrode Dk in the discharge cell where the address discharge has been generated.

Meanwhile, voltages at the intersecting parts between data electrodes D1 to Dm and scan electrode SC1, to which the address pulse voltage Vd(V) has not been applied, do not exceed the discharge starting voltage. Therefore, the address discharge is not generated. The above address operation is sequentially performed up to the discharge cell on the n-th row. The address period is completed when the address operation on the discharge cell on the n-th row is completed.

### 2-1-3. Sustain Period

In the subsequent sustain period, positive sustain pulse voltage Vs(V) as a first voltage is applied to scan electrodes SC1 to SCn. Ground potential, namely 0 (V), is applied as a second voltage to sustain electrodes SU1 to SUn. At this time, in the discharge cell where the address discharge has been generated, a voltage between scan electrode SCi and sustain electrode SUi is one obtained by adding the wall voltage on scan electrode SCi and the wall voltage on sustain electrode SUi to sustain pulse voltage Vs(V), which exceeds the discharge starting voltage. Then, sustain discharge is generated between scan electrode SCi and sustain electrode SUi. By ultraviolet rays generated due to the sustain discharge, the phosphor layer is excited, to emit light. The negative wall voltage is then accumulated on scan electrode SCi. The positive wall voltage is accumulated on sustain electrode SUi. The positive wall voltage is accumulated on data electrode Dk.

In the discharge cell where the address discharge has not been generated in the address period, the sustain discharge is not generated. Therefore, the wall voltage at the completion of the initializing period is held. Subsequently, 0 (V) as the second voltage is applied to scan electrodes SC1 to SCn. Sustain pulse voltage Vs (V) as the first voltage is applied to sustain electrodes SU1 to SUn. Then, in the discharge cell where the sustain discharge has been generated, a voltage between sustain electrode SUi and scan electrode SCi exceeds the discharge starting voltage. Therefore, sustain discharge is again generated between sustain electrode SUi and scan electrode SCi. That is, the negative wall voltage is accumulated on sustain electrode SUi. The positive wall voltage is accumulated on scan electrode SCi.

Hereinafter, as in the above, sustain pulse voltages Vs(V) in the number corresponding to luminance weight are alternately applied to scan electrodes SC1 to SCn and sustain electrodes SU1 to SUn, thereby to continuously generate the sustain discharge in the discharge cell where the address discharge has been generated in the address period. Upon completion of application of a predetermined number of sustain pulse voltages Vs(V), the sustain operation in the sustain period is completed.

### 2-1-4. Second Subfield and Thereafter

Operations in the initializing period, the address period and the sustain period in and after a subsequent second subfield are almost the same as the operations in the first subfield. Therefore, detailed descriptions are omitted. It is to be noted that in and after the second subfield, a selective initializing operation may be performed which selectively generates initializing discharge only in the discharge cell where the sustain discharge has been generated in the previous subfield. In the present embodiment, the all-cell initializing operation and the selective initializing operation are properly used between the first subfield and the other subfields. However, the all-cell cell initializing operation may be performed in the initializing period in the subfields other than the first subfield. Further, the all-cell initializing operation may be performed at a frequency of once in several fields.

Moreover, the operations in the address period and the sustain period are similar to the foregoing operations in the first subfield. However, the operation in the sustain period is not necessarily similar to the foregoing operation in the first subfield. In order to generate the sustain discharge such that luminance corresponding to image signal sig is obtained, the number of sustain discharge pulses Vs(V) changes. That is, in the sustain period, driving is performed so as to control luminance with respect to each subfield.

### 3. Configuration of Rear Plate 60

### 3-1. Summary of Rear Plate 60

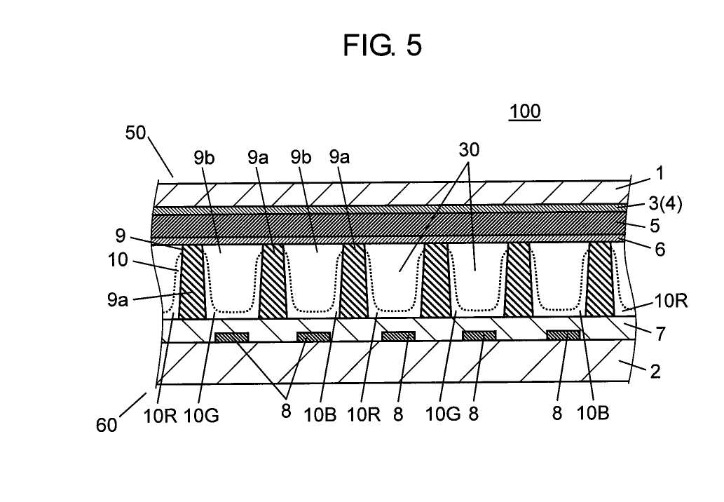

As shown in FIGS. 5 to 7, parallel-cross barrier ribs 9 partition discharge cell 30. Barrier ribs 9 are made up of vertical barrier ribs 9a formed in parallel with data electrodes 8, and horizontal barrier ribs 9b formed so as to be orthogonal to vertical barrier ribs 9a. Further, as shown in FIG. 5, phosphor layer 10 is made up of blue-color phosphor layers 10B that emit blue-color light, red-color phosphor layers 10R that emit red-color light, and green-color phosphor layers 10G that emit green-color light. Blue-color phosphor layer 10B, red-color phosphor layer 10R that emits red-color light and green-color phosphor layer 10G that emits green-color light are sequentially arrayed. Phosphor layer 10 is formed by being applied in stripes along vertical barrier ribs 9a.

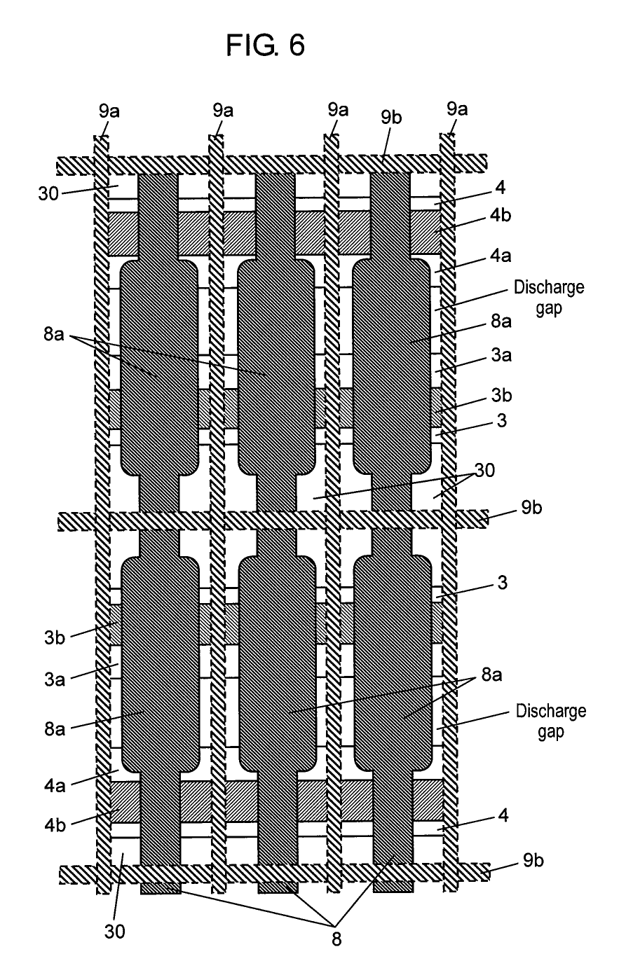

Further, as shown in FIG. 6, data electrodes 8 are formed in stripes in parallel with vertical barrier ribs 9a. Further, data electrode 8 has main electrode sections 8a in which widths of portions opposed to scan electrodes 3 and sustain electrodes 4 are larger than widths of other portions. Main electrode section 8a is located closer to scan electrode 3 side inside discharge cell 30. That is, data electrode 8 has main electrode sections 8a in all of portions opposed to scan electrode 3 and portions opposed to the discharge gaps. On the other hand, data electrode 8 has main electrode sections 8a in portions opposed to part of the discharge gap sides of sustain electrodes 4.

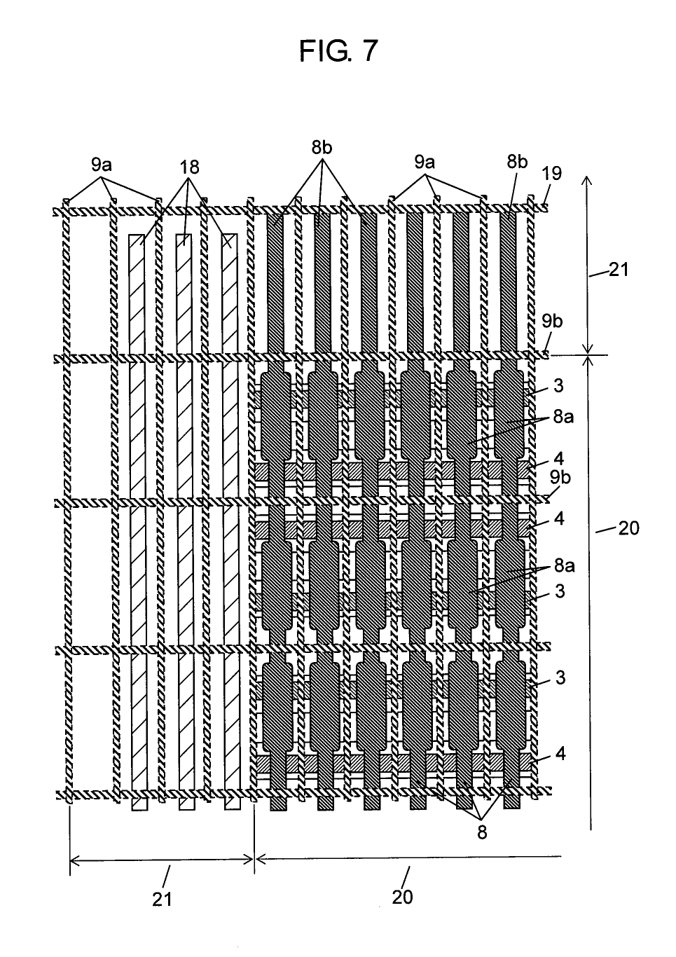

As shown in FIG. 7, PDP 100 has display region 20 formed with a plurality of discharge cells 30, and non-display region 21 provided around display region 20. Barrier ribs 9 are formed in display region 20 and non-display region 21. Further, in non-display region 21, dummy electrodes 18 in parallel with the data electrodes 8 are formed. The relation between data electrodes 8 and barrier ribs 9, and the relation between dummy electrodes 18 and barrier ribs 9 will be described in detail later.

### 3-2. Method for Forming Data Electrodes 8

In the present embodiment, data electrode 8 is formed by photo-lithography. As materials for data electrode 8, silver (Ag) for ensuring conductivity, a glass frit for binding Ag, a photosensitive resin, and a data electrode paste containing a solvent are used. First, by screen printing or the like, the data electrode paste is applied onto rear substrate 2 with predetermined thickness. Next, the solvent in the data electrode paste is removed by a drying furnace. Subsequently, the data electrode paste is exposed via a photomask with a predetermined pattern. Next, the data electrode paste is developed, to form a data electrode pattern. Finally, the data electrode pattern is fired by a firing furnace at a predetermined temperature. That is, the photosensitive resin in the data electrode pattern is removed. Further, the glass frit in the data electrode pattern is melt. The glass frit is re-solidified after the firing. From the above process, data electrode 8 is formed.

Herein, other than the method for screen-printing the data electrode paste, a method for application by die coating or the like may be employed. Further, other than the method using the data electrode paste, there can be employed a method for forming a conductive film by means of sputtering, vapor deposition, or the like, and then performing patterning.

### 3-3. Method for Forming Insulating Layer 7

In the present embodiment, insulating layer 7 is formed by an application method. First, using a die coater or the like, an insulating paste is applied onto rear substrate 2 formed with data electrodes 8, so as to coat data electrodes 8.

The insulating paste in the present embodiment includes a glass frit, a filler, a binder and a solvent. Further, the glass frit does not substantially include lead.

The applied insulating paste forms an insulating paste layer. Thereafter, the insulating paste layer is dried by the drying furnace or the like. By drying, a solvent component in the insulating paste layer is removed. Next, the insulating paste layer is fired. By firing, the binder in the insulating paste layer is removed. Further, the glass frit is melt. The glass frit is re-solidified after the firing. In this manner, insulating layer 7, made up of the grass frit and the filler, is formed.

### 3-4. Method for Forming Barrier Rib 9

In the present embodiment, barrier rib 9 is formed by photo-lithography. As materials for barrier rib 9, a filler, a glass frit for binding the filler, a photosensitive resin, and a barrier rib paste containing a solvent are used. First, the barrier rib paste is applied onto insulating layer 7 with a predetermined thickness by die coating or the like. Next, drying is performed in a predetermined temperature range by a drying furnace. By drying, the solvent in the barrier rib paste is removed. Subsequently, the barrier rib paste is exposed via a photomask with a predetermined pattern. Next, the barrier rib paste is developed, to form a barrier rib pattern. Finally, the barrier rib pattern is fired in a predetermined temperature range by the firing furnace. By the firing, the photosensitive resin in the barrier rib pattern is removed. Further, the glass frit in the barrier rib pattern is melt. The glass frit is re-solidified after the firing. In this manner, barrier ribs 9 are formed.

### 3-4-1. Detail of Barrier Rib Paste

Moreover, for the barrier rib paste, a polymeric initiator or an organic solvent can be used as another organic component, and further, if necessary, a nonphotosensitive polymer component or an additive component, such as antioxidant, an organic colorant, a sensitizer, a sensitizing auxiliary, a plasticizer, a thickener, a dispersant or a precipitation inhibitor can be used. The barrier rib paste according to the present embodiment is preferably an alkali-developable photosensitive barrier rib paste layer. Herein, an “alkali-developable” one means one having properties of being resolvable into an alkali water-based developing agent with a pH of 9 to 14 but not resolvable into a neutral water-based developing agent with a pH of 6 to 8 in a state before exposure in the case of exposure using a negative mask. Meanwhile, it means one having a property of being resolvable into neither an alkali water-based developing agent with a pH of 9 to 14 nor a neutral water-based developing agent with a pH of 6 to 8 after exposure.

As the photosensitive polymer, an alkali-soluble polymer may be preferably used. This is because, with the photosensitive polymer having alkali-solubility, an alkali solution can be used as the developing agent instead of an organic solvent which is problematic in terms of environment. As the alkali-soluble polymer, an acrylic copolymer can be preferably used. The acrylic copolymer is a copolymer at least containing an acrylic monomer as a copolymer component.

The non-photosensitive polymer component is, for example, a cellulose compound such as methyl cellulose or ethyl cellulose, or high-molecular-weight polyether or the like. Further, the photosensitive monomer is a compound including carbon-carbon unsaturated binding.

The above variety of components are blended so as to have a predetermined composition, which is then homogeneously mixed and dispersed by means of triple rollers or a kneading machine so that the barrier rib paste can be produced.

As a device for application of the barrier rib paste, there can be employed a screen printer, a die coater, a blade coater, or the like. The application thickness can be adjusted by means of the number of times of application, a mesh of a screen plate, viscosity of the paste, or the like. For drying, a hot-air drying furnace, an infrared drying furnace, or the like is used. The drying temperature and the drying time are appropriately adjusted by means of the solvent of the barrier rib paste used or the application film thickness.

In the present embodiment, as the photosensitive resin, a negative type is used. That is, solubility of the exposed portion to the developing agent increases. As the photomask used for exposure, a negative type is selected. As an exposure device, a stepper exposure device, a proximity exposure device, or the like can be used. A wavelength of light is a wavelength with which the light polymeric initiator contained in the barrier rib paste is reacted. Generally, light with a wavelength of 250 to 450 nm is used. As a light-emitting device, an excimer lamp, a low-pressure mercury lamp, a high-pressure mercury lamp, or the like is used.

Incidentally, at the time of exposure, light may also reflect from the lower layer of the barrier rib paste. Herein, in the case of data electrode 8 being formed in a lower layer of the barrier rib paste, a reflectance decreases as compared with the case of data electrode 8 being not formed in the lower layer of the barrier rib paste. When the reflectance from the lower layer of the barrier rib paste decreases, an exposure amount of the vicinity of the bottom of the barrier rib paste decreases. That is, the bottom width of barrier rib 9 becomes smaller. When the bottom width of barrier rib 9 becomes smaller, adhesion force to insulating layer 7 decreases. This tends to lead to occurrence of peeling of barrier ribs 9.

However, even when the reflectance from the lower layer of the barrier rib paste decreases, the bottom width of barrier rib 9 can be adjusted by setting of the exposure amount. Therefore, data electrode 8 may have reached to the lower layer of a region where outermost barrier rib 9 is formed. Meanwhile, since dummy electrode 18 is not applied with the drive voltage, it may be formed in a variety of shapes so as to be used for checking a process margin, and the like. It is thus preferable that dummy electrode 18 be not formed in the lower layer of the region formed with outermost barrier rib 9. In other words, it is preferable that outermost barrier rib 9 be opposed to data electrode 8 via insulating layer 7, and not opposed to dummy electrode 18. When dummy electrode 18 is formed in the lower layer of the region where outermost barrier rib 9 is formed, the reflectance varies in the case of a variety of shapes having been formed in the dummy electrode 18. That is, in the case of the dummy electrode being formed in the lower layer of the wall paste, even if the bottom width of barrier rib 9 in display region 20 is adjusted by setting of the exposure amount, the bottom width of barrier rib 9 in non-display region 21 may become smaller. Therefore, peeling of the barrier rib 9 in non-display region 21 may occur.

### 4. Summary

Plasma display device 200 according to the present embodiment includes PDP 100. PDP 100 has display region 20 and non-display region 21 formed around display region 20. Rear plate 60 has data electrodes 8 that give a drive voltage to rear plate 60, dummy electrode 18 that is in parallel with data electrodes 8 and does not give a drive voltage to rear plate 60, insulating layer 7 that coats data electrodes 8 and dummy electrode 18, and a plurality of horizontal barrier ribs 9b formed on insulating layer 7 and orthogonal to data electrodes 8. Data electrode 8 is provided in display region 20 and non-display region 21. Dummy electrode 18 is arranged in non-display region 21. Insulating layer 7 is arranged in display region 20 and non-display region 21. Outermost horizontal barrier rib 19 as an outermost barrier rib is arranged in non-display region 21. Outermost horizontal barrier rib 19 is opposed to data electrode 8 via insulating layer 7, and not opposed to dummy electrode 18.

Accordingly, in plasma display device 200 disclosed in the present embodiment, peeling of barrier ribs 9 in non-display region 21 can be reduced.

### 5. Examples

Plasma display device 200 has been produced. PDP 100 used in produced plasma display device 200 is one to be fitted to a 42-inch class full high-definition television. That is, PDP 100 includes front plate 50 and rear plate 60 arranged as opposed to the front plate 50. Further, the peripheries of front plate 50 and rear plate 60 are sealed with a sealing member. Front plate 50 has a plurality of scan electrodes 3, a plurality of sustain electrodes 4, dielectric layer 5 and protective layer 6. Rear plate 60 has data electrodes 8, insulating layer 7, barrier ribs 9, and phosphor layer 10. A neon (Ne)-xenon (Xe) based mixed gas with a content of xenon (Xe) being 15 vol % is filled into PDP 100 with an inner pressure of 60 kPa. Further, vertical barrier rib 9a has a height of 120 μm and a width of 40 μm, and horizontal barrier rib 9b has a height of 115 μm and a width of 35 μm. An interval (cell pitch) between vertical barrier ribs 9a is 150 μm. Further, data electrode 8 has a width of 65 μm, and dummy electrode 18 has a width of 65 μm. Insulating layer 7 has a thickness of 10 μm.

In the example, as shown in FIGS. 2, 5 and 7, it is configured such that data driver 13a as a drive circuit, connected to one end of data electrode 8, is provided and the other end side of data electrode 8, which is not connected to data driver 13a, is opposed to outermost horizontal barrier rib 19 via insulating layer 7. Further, in the example, as shown in FIGS. 2, 5 and 7, it is configured such that outermost horizontal barrier rib 19 opposed to the other end side of data electrode 8, which is not connected to data driver 13a, via insulating layer 7 is not opposed to dummy electrode 18. Moreover, in the example, as shown in FIGS. 2, 5 and 7, it is configured such that the other end side of data electrode 8, which is not connected to data driver 13a, is terminated at a position opposed to outermost horizontal barrier rib 19 via insulating layer 7.

The present inventors have confirmed non-occurrence of peeling of barrier rib 9 in non-display region 21 of the example. Further, in the configuration of the example, design flexibility of dummy electrode 18 can be enhanced.

It is to be noted that, even when vertical barrier rib 9a is further formed in a direction from outermost horizontal barrier rib 19 to the periphery of PDP 100, with data electrode 8 terminated at the position opposed to outermost horizontal barrier rib 19 via insulating layer 7, a decrease in reflectance can be suppressed. Therefore, in the configuration of the example, a design margin of a photomask for barrier ribs 9 can be made wider.

Incidentally, cost-reducing methods for plasma display device 200 include cost reduction in drive circuit that drives PDP 100, other than const reduction in PDP 100. As a method for realizing cost reduction in drive circuit, there is a method for reducing the number of components constituting the drive circuit. One example of the methods for reducing the number of components is reducing data electrode drive circuit 13. Specifically, as shown in FIG. 2, a so-called single scan system is adopted in which data electrode drive circuit 13 is connected to only one end of data electrode 8. In the single scan system, in order to reduce a load on data electrode drive circuit 13, a data current flowing through data electrode 8 is required to be reduced.

Data electrode 8 in the present embodiment has main electrode sections 8a as described above. Therefore, reducing widths of portions other than main electrode section 8a used for discharging PDP 100 can reduce a data current flowing through data electrode 8 in a address period. Hence plasma display device 200 according to the present embodiment can realize the single scan system. Plasma display device 200 according to the present embodiment can thus realize low power consumption.

### 6. Other Embodiments

It should be noted that in FIG. 7, a mode is shown as an example where barrier ribs 9 with respect to one block of discharge cell 30 are formed in a longitudinal direction of data electrode 8 in non-display region 21. Further, a mode is shown where barrier ribs 9 with respect to four blocks of discharge cells 30 are formed in the array direction of data electrode 8. However, the number of barrier ribs 9 formed in non-display region 21 is not limited to the present embodiment. That is, for example, barrier ribs 9 with respect to nine blocks may be formed in the longitudinal direction and the array direction of data electrode 8. Further, the number of dummy electrodes 18 is not limited to three, but may be one. Alternatively, the number of dummy electrodes may be five or six.

### INDUSTRIAL APPLICABILITY

The technique disclosed in the present embodiment as above is useful in realizing a high-quality plasma display device.

### REFERENCE MARKS IN THE DRAWINGS

1 front substrate
2 rear substrate
3 scan electrode
4 sustain electrode
3a, 4a transparent electrode
3b, 4b bus electrode
5 dielectric layer
6 protective layer
7 insulating layer
8 data electrode
9 barrier rib
9a vertical barrier rib
9b horizontal barrier rib
10 phosphor layer
12 image signal processing circuit
13 data electrode drive circuit
13a data driver
14 scan electrode drive circuit
15 sustain electrode drive circuit
16 timing generation circuit
17 sustain pulse generator
18 dummy electrode
19 outermost horizontal barrier rib
20 display region
21 non-display region
30 discharge cell
50 front plate
60 rear plate
100 PDP
200 plasma display device

1. A plasma display device comprising a plasma display panel that has a front panel and a rear panel opposed to the front panel,
wherein the plasma display panel includes a display region and a non-display region formed around the display region,
wherein the rear panel includes:
an electrode applying a drive voltage to the rear panel;
a dummy electrode disposed in parallel with the electrodes and not applying a drive voltage to the rear panel;
an insulating layer coating the electrode and the dummy electrode; and
a plurality of barrier ribs formed on the insulating layer and orthogonal to the electrode,
wherein the electrode is disposed in the display region and the non-display region, the dummy electrode is disposed in the non-display region, the insulating layer is disposed in the display region and the non-display region, an outermost barrier rib of the barrier ribs is disposed in the non-display region and is opposed to the electrode via the insulating layer but is not opposed to the dummy electrode.

2. The plasma display device according to claim 1, further comprising a drive circuit connected to one end of the electrode,
wherein the other end of the electrode, which the other end is not connected to the drive circuit, is opposed to the outermost barrier rib via the insulating layer.

3. The plasma display device according to claim 2, wherein the outermost barrier rib opposed to the other end side of the electrode, which the other end is not connected to the drive circuit, via the insulating layer is not opposed to the dummy electrode.

4. The plasma display device according to claim 2, wherein the other end side of the electrode, which the other end is not connected to the drive circuit, is terminated at a place opposed to the outermost barrier rib via the insulating layer.

5. The plasma display device according to claim 3, wherein the other end side of the electrode, which the other end is not connected to the drive circuit, is terminated at a place opposed to the outermost barrier rib via the insulating layer.
